(19) United States
(12) Patent Application Publication
(10) Pub. No.: US 2026/0154562 A1
(43) Pub. Date: Jun. 4, 2026

(54) METHOD AND APPARATUS FOR TRAIN RE-SCHEDULING BASED ON DIFFUSION MODEL AND REINFORCEMENT LEARNING

(71) Applicants: Westlake University, Hangzhou (CN); Guangdong University of Foreign Studies, Guangzhou (CN)

(72) Inventors: Yaochu JIN, Hangzhou (CN); Xueming YAN, Guangzhou (CN)

(21) Appl. No.: 19/273,278

(22) Filed: Jul. 18, 2025

(30) Foreign Application Priority Data
Dec. 4, 2024 (CN) 202411774175.8

(51) Int. Cl. G06N 3/092; B61L 27/12

(52) U.S. Cl. CPC G06N 3/092; B61L 27/12

(57) ABSTRACT

The present disclosure provides a method and an apparatus for train re-scheduling based on a diffusion model and reinforcement learning. A method for train re-scheduling includes: obtaining time series data indicating states, including a train operation state, a resource allocation state and an external environment state, at respective time points during a train operation process; providing the obtained time series data to a trained neural network model to generate a scheduling strategy for train re-scheduling, the scheduling strategy including an action to be performed by a train scheduling system; and instructing the train scheduling system to perform the generated scheduling strategy, where the neural network model includes a diffusion model and a reinforcement learning model.

### CROSS-REFERENCE TO RELATED APPLICATION

This application is based on and claims the priority of the Chinese patent application No. 202411774175.8 filed on Dec. 4, 2024, the disclosure of which is incorporated herein by reference in its entirety.

### TECHNICAL FIELD

The present disclosure relates to the field of train scheduling technology, and more particularly, to a method for train re-scheduling, a method for training a neural network model for train re-scheduling, as well as related computing devices, non-transitory computer-readable storage media, and a train scheduling system.

### BACKGROUND

With the rapid development of artificial intelligence, big data, and multimodal information fusion technology, train scheduling systems are gradually developing from the traditional way relying on fixed timetables and manual decision-making to intelligent, automated, and unmanned operations.

### SUMMARY

A brief overview of the present disclosure is given below to provide a basic understanding of some aspects of the present disclosure. However, it should be understood that this overview is not an exhaustive overview of the present disclosure. It is not intended to identify the key or important parts of the present disclosure, nor is it intended to limit the scope of the present disclosure. Its purpose is simply to give some concepts of the present disclosure in a simplified form as a prelude to a more detailed description given later.

According to a first aspect of the present disclosure, a method for train re-scheduling is provided. The method includes: obtaining time series data indicating states at respective time points during a train operation process, the states including a train operation state, a resource allocation state and an external environment state; providing the obtained time series data to a trained neural network model to generate a scheduling strategy for train re-scheduling, the scheduling strategy including an action to be performed by a train scheduling system; and instructing the train scheduling system to perform the generated scheduling strategy, wherein the time series data has different noise in a case where an emergency occurs during the train operation process compared with a case where no emergency occurs during the train operation process, and wherein the neural network model includes a diffusion model and a reinforcement learning model, the diffusion model is configured to remove the noise in the time series data based on a reverse diffusion process to obtain denoised time series data, and the reinforcement learning model is configured to generate the scheduling strategy based on the denoised time series data.

According to a second aspect of the present disclosure, a method of training a neural network model for train re-scheduling is provided. The neural network model includes a diffusion model and a reinforcement learning model, and the method includes: obtaining historical time series data indicating states at respective time points during a historical train operation process and a historical train scheduling strategy corresponding to the historical train operation process, the states including a train operation state, a resource allocation state and an external environment state, the historical train scheduling strategy including an action that was performed by a train scheduling system; adding noise to the historical time series data based on a forward diffusion process through the diffusion model to obtain noise-added historical time series data; and training the reinforcement learning model by using the noise-added historical time series data as sample data and using the historical train scheduling strategy as label data.

According to a third aspect of the present disclosure, a computing device is provided. The computing device includes a processor and a memory storing computer-executable instructions that, when executed by the processor, cause the processor to perform the method for train re-scheduling according to the first aspect of the present disclosure or the method of training a neural network model for train re-scheduling according to the second aspect of the present disclosure.

According to a fourth aspect of the present disclosure, a non-transitory computer-readable storage medium having computer-executable instructions stored thereon is provided, wherein the computer executable instructions, when executed by a processor, cause the processor to perform the method for train re-scheduling according to the first aspect of the present disclosure or the method of training a neural network model for train re-scheduling according to the second aspect of the present disclosure.

According to a fifth aspect of the present disclosure, a train scheduling system is provided, which includes a computing device and an execution apparatus. The computing device includes a processor and a memory coupled to the processor and storing instructions that, when executed by the processor, cause the processor to: obtain time series data indicating states at respective time points during a train operation process, the states including a train operation state, a resource allocation state and an external environment state; providing the obtained time series data to a trained neural network model to generate a scheduling strategy for train re-scheduling, the scheduling strategy including an action to be performed by a train scheduling system, wherein the time series data has different noise in a case where an emergency occurs during the train operation process compared with a case where no emergency occurs during the train operation process, and wherein the neural network model includes a diffusion model and a reinforcement learning model, the diffusion model is configured to remove the noise in the time series data based on a reverse diffusion process to obtain denoised time series data, and the reinforcement learning model is configured to generate the scheduling strategy based on the denoised time series data; and send the generated scheduling strategy to the execution apparatus communicatively coupled to the computing device. The execution apparatus is configured to perform the scheduling strategy in response to receiving the scheduling strategy from the computing device.

### BRIEF DESCRIPTION OF THE DRAWINGS

The foregoing and other features and advantages of the present disclosure will become apparent from the following description of embodiments of the present disclosure in conjunction with the accompanying drawings. The accompanying drawings are incorporated herein and form a part of the specification, and are further used to explain the principles of the present disclosure and enable those skilled in the art to make and use the present disclosure, wherein:

FIG. 1 is a flowchart showing a method for train re-scheduling according to some embodiments of the present disclosure;

FIG. 2 is a flowchart showing a method for training a neural network model including a diffusion model and a reinforcement learning model for train re-scheduling, according to some embodiments of the present disclosure;

FIG. 3 is a schematic block diagram showing a computing device according to some embodiments of the present disclosure;

FIG. 4 is a schematic block diagram showing a computer system on which embodiments of the present disclosure can be implemented; and

FIG. 5 is a schematic block diagram showing a train scheduling system according to some embodiments of the present disclosure.

It is noted that in the embodiments described below, sometimes the same reference numerals are used in common between different drawings to represent the same parts or parts with the same functions, and their repeated descriptions are omitted. In some cases, similar numbers and letters are used to represent similar items, so once an item is defined in one drawing, it does not need to be further discussed in subsequent drawings.

For case of understanding, the positions, dimensions, ranges, etc. of structures shown in the drawings and the like may not represent the actual positions, dimensions, ranges, etc. Therefore, the present disclosure is not limited to the positions, dimensions, ranges, etc. disclosed in the drawings and the like.

### DETAILED DESCRIPTION

Various illustrative embodiments of the present disclosure will be described in detail below with reference to the accompanying drawings. It should be noted that unless otherwise specifically stated, the relative arrangement of components and steps, numerical expressions and numerical values set forth in these embodiments do not limit the scope of the present disclosure.

The following description of at least one illustrative embodiment is in fact merely illustrative and is in no way intended to limit the present disclosure and its application or use. That is, the structures and methods herein are shown as examples to illustrate different embodiments of the structures and methods in the present disclosure. However, those skilled in the art will appreciate that they merely describe illustrative ways of the present disclosure that can be implemented, rather than exhaustive ways. In addition, the drawings need not be drawn to scale, and some features may be enlarged to illustrate the details of specific components.

In addition, technologies, methods, and devices known to ordinary technicians in the relevant art may not be discussed in detail, but where appropriate, the technologies, methods, and devices should be considered as a part of the specification.

In all examples shown and discussed herein, any specific values should be interpreted as merely illustrative and not as limiting. Therefore, other examples of the illustrative embodiments may have different values.

At present, a train scheduling system still mainly relies on fixed timetables and manual scheduling decision-making, which has a low level of intelligence, lacks autonomous learning and decision-making capabilities, and has difficulty in quickly and automatically responding to dynamically changing operation environments. Especially when being faced with emergencies (such as bad weather, device failures, etc.), the flexibility and real-time adjustment capabilities of the train scheduling system are obviously insufficient, making it impossible to efficiently adjust the train operation plan, which easily leads to train delays and service interruptions.

In addition, the current train scheduling method has a problem of unbalanced resource allocation, resulting in the failure to optimize the use of resources such as tracks, trains and manpower. For example, during the peak period of train operation, the shortage of resources exacerbates this problem, while during the non-peak period of train operation, the idleness of resources causes waste.

To this end, the present disclosure provides a method for train re-scheduling that achieves autonomous learning and decision-making in complex scenarios, as well as effective emergency response. This is accomplished through a neural network model for train re-scheduling, constructed by integrating a diffusion model and a reinforcement learning model. The method according to the present disclosure can dynamically adjust the train operation plan in real time, optimize resource allocation, respond flexibly to emergencies, and enhance the overall operation efficiency and reliability of the train system.

Hereafter, the method for train re-scheduling according to various embodiments of the present disclosure will be described in detail with reference to the accompanying drawings. It can be understood that the actual method for train re-scheduling may also include other steps, but in order not to obscure the main points of the present disclosure, these other steps are neither discussed herein nor shown in the accompanying drawings.

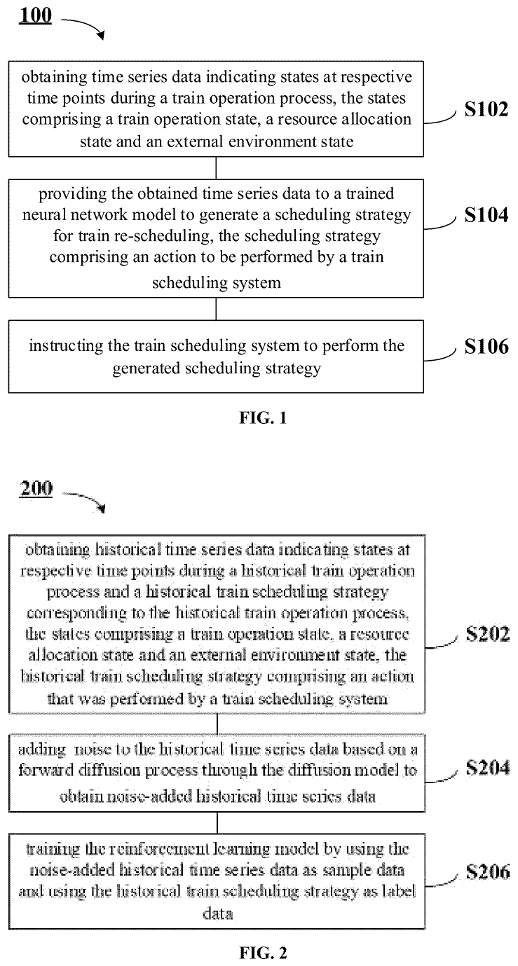

FIG. 1 is a flowchart showing a method 100 for train re-scheduling according to some embodiments of the present disclosure. As shown in FIG. 1, the method 100 includes steps S102 to S106.

At step S102, time series data indicating states, including a train operation state, a resource allocation state and an external environment state, at respective time points during a train operation process is obtained. In some embodiments, the train operation state may include a current position, speed, planned arrival time, and the like of the train, the resource allocation state may include a station condition, track availability, and the like, and the external environment state may include a weather condition, a device condition, a passenger condition, and the like.

In some embodiments, the states at the respective time points during the train operation process are obtained using a state detection apparatus. The states at the respective time points during the train operation process can be detected by the state detection apparatus to obtain the time series data. For example, the state detection apparatus may be implemented as, or may include, or may communicate with, various measuring devices such as sensors. As a non-limiting implementation, the state detection apparatus may include, for example, one or more of: a speed sensor for detecting the speed of the train, a position sensor for detecting the position of the train, a communication apparatus capable of obtaining the weather condition (for example, the communication apparatus can communicate with the Internet to obtain the weather condition), a communication apparatus capable of communicating with the Road Traffic Control Center (RTC) for the train to obtain track availability, and a platform camera capable of detecting conditions of passengers on a platform, etc. In some examples, the speed of the train at the respective time points during the train operation process can be detected by the speed sensor to obtain time series data indicating the speeds of the train at the respective time points.

Herein, “noise” may be used to describe a degree of complexity and/or uncertainty of the train scheduling scenario or the train operation environment. For example, the time series data may have different noise in a case where an emergency occurs during the train operation process compared with a case where no emergency occurs during the train operation process.

In some embodiments, the emergencies may include device failure (e.g., track signal failure, train failure, power outage, etc.), bad weather (e.g., heavy rain, heavy snow, strong wind, etc.), and passenger emergency (e.g., medical emergency, overloading, congestion, etc.).

It can be understood that the time series data for the train operation process in which no emergency occurs may have a relatively stable noise distribution characteristic. Once an emergency occurs in the train operation process, the emergency will disturb a state at a corresponding time point (and possibly some subsequent time points thereof), thereby causing a change in the noise distribution characteristics of the time series data, such as increased noise at the corresponding time point (and possibly some subsequent time points thereof).

In some embodiments, for example, regarding a first emergency and a second emergency of different types or priorities, the time series data may have different noise in a case where the first emergency occurs during the train operation process compared with a case where the second emergency occurs during the train operation process. For example, different emergencies may be characterized by noise with different characteristics, such as but not limited to the distribution that the noise follows (e.g., standard normal distribution or Gaussian distribution, etc.), the strategy of noise variation (i.e., a function of noise over time, such as a linear noise strategy, a cosine noise strategy, an exponential noise strategy, etc.), the weight of the noise, and the like.

As an illustration, it can be assumed that the first emergency is a track signal failure and the second emergency is a medical emergency. An adjustment of the train scheduling strategy corresponding to the track signal failure is to solve the device failure as soon as possible to reduce the impact on the train operation while ensuring the normal operation of the train, and an adjustment of the train scheduling strategy corresponding to the medical emergency is to determine an appropriate station to stop as soon as possible to provide the passenger with sufficient medical resources. Since the occurrence of emergencies of different types causes different degrees of disturbance to the operation of the train system, the noise with different characteristics in the time series data can characterize the corresponding emergencies of different types.

In some examples, different types of emergencies may have different priority levels. For example, the track signal failure and bad weather events may be considered to have higher priorities, while passenger congestion and individual device failure may be considered to have lower priorities. In addition, in some examples, even emergencies of the same type may have different priorities depending on impact thereof. For example, a small-scale bad weather event (such as bad weather across a single station area) may have a lower priority than that of a large-scale bad weather event (such as bad weather across an entire operation route area). Therefore, emergencies of different priorities may be characterized by noise patterns with distinct characteristics.

For example, it may be assumed that when a starting station and a terminal station of a train are Shanghai Station and Fuzhou Station respectively, the first emergency is heavy rainfall in East China, and the second emergency is heavy rainfall in a local area of Shanghai. Since the first emergency is a large-scale bad weather event and covers the entire operation route of the train, the priority of the first emergency is higher than the priority of the second emergency. Accordingly, a weight of noise used to characterize the first emergency may be greater than a weight of noise used to characterize the second emergency, so that the scheduling strategy generated by method 100 can give priority to the first emergency.

At step S104, the obtained time series data is provided to a trained neural network model to generate a scheduling strategy for train re-scheduling, the scheduling strategy including an action to be performed by a train scheduling system. In some embodiments, actions that can be performed by the train scheduling system include determining train departure time and arrival time, determining train operation priority, selecting a track, and selecting a station, etc.

The neural network model includes a diffusion model and a reinforcement learning model. For example, the diffusion model may be regarded as a form of variational inference, which uses a denoising network to converge towards a true sample step by step across a sequence of estimation steps. The reinforcement learning model is a branch of machine learning models, and involves learning performed by an agent through trial-and-error and feedback in an environment, aiming to maximize a cumulative reward. The specific model structures and algorithms of the diffusion model and the reinforcement learning model are not limited in the present disclosure, and any diffusion model and reinforcement learning model known at present or developed in the future may be applied to various embodiments of the present disclosure.

In the neural network model according to the present disclosure, the diffusion model is configured to remove the noise in the time series data based on a reverse diffusion process to obtain denoised time series data, and the reinforcement learning model is configured to generate the scheduling strategy based on the denoised time series data.

In some embodiments, removing the noise in the time series data based on the reverse diffusion process includes:

$${x}_{t - 1} = \frac{1}{\sqrt{{α}_{t}}} [ {x}_{t} - \frac{1 - {α}_{t}}{\sqrt{1 - {β}_{t}}} {ℰ}_{θ} ( {x}_{t} , t ) ] + {σ}_{t} z ,$$

where
the time series data includes (T+1) time points, the time series data indicates a state x₀ at time point 0 and indicates a state x_{T} at time point T,
the reverse diffusion process is defined as a diffusion process from the state x_{T} to the state x₀ along a Markov chain consisting of T time steps, t is a time step in the Markov chain, where t∈[1, T],
the state xₜ₋₁ represents a state obtained from the state xₜ after one step of denoising,
ε_{θ}(xₜ, t) represents noise predicted for the state xₜ and the time step t (for example, via the denoising network in the diffusion model), θ represents a scheduling strategy parameter,

$${α}_{t} = 1 - {β}_{t} , {β}_{t} = {σ}_{t}^{2} ,$$

σ^{t} represents a noise coefficient at the time step t and may also be called noise scheduling, and
z represents Gaussian noise, and z˜N(0,I) represents that z is sampled from a standard normal distribution with a mean of 0 and a variance of I, which can be used to further adjust the denoising effect.

In some embodiments, σₜ is determined based on an emergency occurring at the time step t.

In some further embodiments, σₜ may be determined based on one of following noise strategies: σₜ is determined as

$${σ}_{min} + \frac{t}{T} ( {σ}_{max} - {σ}_{min} )$$

based on a linear noise strategy; or σₜ is determined as

$${σ}_{t} = {σ}_{max} \cdot cos ( \frac{π t}{2 T} )$$

based on a cosine noise strategy; or σₜ is determined as

$${σ}_{min} \cdot {( \frac{{σ}_{max}}{{σ}_{min}} )}^{\frac{t}{T}}$$

based on an exponential noise strategy, where σₘᵢₙ represents a minimum noise coefficient for the T time steps, and σₘₐₓ represents a maximum noise coefficient for the T time steps. As a non-limiting example, σₘᵢₙ=0.1 and σₘₐₓ=1 may be set.

In the above embodiment, for different noise strategies, the change pattern of σₜ over time is different, which correspondingly causes the change pattern of the noise item σₜz over time to be different. Depending on whether an emergency occurs and what type of emergency occurs, a corresponding noise strategy is selected. In some examples, the rate of change of σₜ over time can increase in a case where an emergency occurs compared to a case where no emergency occurs. In some examples, the higher the priority of the emergency that occurs, the greater the rate of change of σₜ over time can be. For example, the noise strategy can be selected based on the following operations: in response to no emergency occurring at the time step t, the linear noise strategy is selected; in response to an emergency with a first priority occurring at the time step t, the cosine noise strategy is selected; and in response to an emergency with a second priority occurring at the time step t, the exponential noise strategy is selected, where the second priority is higher than the first priority.

For example, in the train operation process, when no emergency occurs, the linear noise strategy is selected, and σₜ is determined as

$${σ}_{min} + \frac{t}{T} ( {σ}_{max} - {σ}_{min} ) .$$

As the train runs, when the emergency of “heavy rainfall in a local area of Shanghai” occurs, it is considered that this emergency has the first priority, so the cosine noise strategy is selected and σₜ is determined as

$${σ}_{t} = {σ}_{max} \cdot cos ( \frac{π t}{2 T} ) ,$$

and the noise at this time may be increased compared to the original noise when it is assumed that this emergency does not occur at this time. As time goes by, the emergency is upgraded to “heavy rainfall in East China”, then it is considered that the priority of the emergency becomes the second priority, so the exponential noise strategy is selected and σₜ is determined as

$${σ}_{min} \cdot {( \frac{{σ}_{max}}{{σ}_{min}} )}^{\frac{t}{T}}$$

based on the exponential noise strategy, and the rate of change of noise over time at this time will become larger and larger. By representing the occurrence and development of emergencies in the train operation process from the perspective of noise, the neural network model can adjust the train scheduling strategy in time, thereby realizing the train re-scheduling for the emergency.

Combined with the above description of the priorities of emergencies, it can be understood that by selecting, according to the priority of the emergency, the corresponding noise strategy to configure σₜ, the convergence speed of the neural network model can be adaptively controlled to quickly adjust the scheduling strategy of the train, so that the train can respond to emergencies of different priorities in a timely manner according to the adjusted scheduling strategy.

Thus, the diffusion model removes the noise in the time series data through the reverse diffusion process to preprocess the input data for the reinforcement learning model, so that the reinforcement learning model can generate an optimized accurate scheduling strategy from a complex and uncertain environment. Since the neural network model according to the present disclosure makes decisions based on the denoised states, it can be ensured that the train scheduling process is more robust.

In some embodiments, the above-mentioned neural network model is trained by the following steps: obtaining historical time series data indicating states, including a train operation state, a resource allocation state and an external environment state, at respective time points during a historical train operation process and a historical train scheduling strategy corresponding to the historical train operation process, the historical train scheduling strategy including an action that was performed by a train scheduling system; adding noise to the historical time series data based on a forward diffusion process through the diffusion model to obtain noise-added historical time series data; and training the reinforcement learning model by using the noise-added historical time series data as sample data and using the historical train scheduling strategy as label data.

In some examples, the states at the respective time points during the historical train operation process is obtained by using the state detection apparatus. The historical time series data may be obtained through detecting the states at the respective time points during the historical train operation process by the state detection apparatus.

Further, in some embodiments, adding the noise to the historical time series data based on the forward diffusion process includes: x₁=\sqrt{αₜ}x₀+\sqrt{1−αₜ} ε, where
the historical time series data includes (T+1) time points, the historical time series data indicates a state x₀ at time point 0 and indicates a state x_{T} at time point T,
the forward diffusion process is defined as a diffusion process from the state x₀ to the state x_{T} along a Markov chain consisting of T time steps, t is a time step t in the Markov chain, where t∈[1, T],
the state xₜ represents a state obtained from the state x₀ after t steps of noise-adding,
αₜ represents a weight coefficient used to control noise-adding at the time step t, and
ε represents Gaussian noise, and ε˜N (0, I) represents that ε is sampled from a standard normal distribution with a mean of 0 and a variance of I, which can be used for injection into the state.

In some embodiments, αₜ decreases as t increases.

In some other embodiments,

$${α}_{t} = 1 - {σ}_{t}^{2} ,$$

and σₜ represents a noise coefficient at the time step t and is determined based on an emergency that is simulated to occur at the time step 1.

In some further embodiments, σₜ may be determined based on one of following noise strategies: σₜ is determined as

$${σ}_{min} + \frac{t}{T} ( {σ}_{max} - {σ}_{min} )$$

based on the linear noise strategy; or σₜ is determined as

$${σ}_{t} = {σ}_{max} \cdot cos ( \frac{π t}{2 T} )$$

based on the cosine noise strategy; or σₜ is determined as

$${σ}_{min} \cdot {( \frac{{σ}_{max}}{{σ}_{min}} )}^{\frac{t}{T}}$$

based on the exponential noise strategy. As a non-limiting example, σₘᵢₙ=0.1 and σₘₐₓ=1 may be set.

In the above embodiment, the noise strategy can be selected based on the following operations: in response to simulating that no emergency occurs at the time step t, the linear noise strategy is selected; in response to simulating that an emergency with a first priority occurs at the time step t, the cosine noise strategy is selected; and in response to simulating that an emergency with a second priority occurs at the time step t, the exponential noise strategy is selected, where the second priority is higher than the first priority.

The diffusion model generates the sample data by gradually adding the noise to the historical time series data through the forward diffusion process, so as to enable the reinforcement learning model to better learn how to make robust decisions in complex and uncertain environments. The reinforcement learning model trained in this way can handle environments with high noise, thereby ensuring that robust and efficient scheduling strategies can be generated even under conditions with high noise and uncertainty.

In some embodiments, a loss function of the neural network model is determined as:

$$L ( θ ) = {L}_{d} ( θ ) + {L}_{q} ( θ ) ,$$

where
θ represents a scheduling strategy parameter and can be optimized through training,
L(θ) represents the loss function of the neural network model,
L_{d} (θ) represents a behavior cloning loss and can be used to describe a difference between an action a generated based on θ and an action in the historical train scheduling strategy, and

$${L}_{d} ( θ ) = {E}_{i ∼ U , ε \sim N ( 0 , I ) , ( s , a ) \sim D} [ {‖ ε - {ε}_{θ} ( \sqrt{{\overline{α}}_{i}} a + \sqrt{1 - {\overline{α}}_{i}} ε , s , i ) ‖}^{2} ] ,$$

where L_{q} (θ) represents a Q-Learning loss and can be used to describe a difference between a (train) scheduling strategy π_{θ} and the historical train scheduling strategy, and

$${L}_{q} ( θ ) = - α \cdot {E}_{s ∼ D , {a}_{0} ∼ {π}_{θ} ( \cdot \vert S )} [ {Q}_{φ} ( s , {a}_{0} ) ] ,$$

where
E is an expectation symbol, which represents an average value sampled from an empirical dataset D including the historical time series data and the historical train scheduling strategies,
i represents a time step in the diffusion process, i˜U represents that i is sampled from a uniform distribution U, and in the scheduling strategy, i may be understood as different stages of the scheduling process,
ε represents noise, ε˜N(0, I),
(s, a)˜D represents that a state S and a corresponding action @ are sampled from the empirical dataset D,
ε_{θ}(\sqrt{α̅ᵢ}a+\sqrt{1−α̅ᵢ}ε, s, i) represents the noise predicted for the state S, the action a, and the time step i (for example, through a denoising network) and is used to predict the noise level of the train system in the diffusion process,
α̅ᵢ is a cumulative weight coefficient for controlling noise-adding from the time step 1 to the time step

$$i , {\overline{α}}_{i} = {\prod }_{l = 1}^{i} {α}_{t} ,$$

where ∥⋅∥² represents the square of the 2-norm and is used to calculate a difference between the predicted noise and the real noise,
α represents a learning rate coefficient, and 0≤α≤1,
s˜D represents that the state S is sampled from the empirical dataset D,
a₀˜π_{θ}(⋅|s) represents that the action a₀ is generated from the scheduling strategy π_{θ}(⋅|s), and the scheduling strategy π_{θ}(⋅|s) represents a probability distribution of selecting a corresponding action under the state s, and

Q_{φ}(s, a₀) is a Q-value function, which represents an expected cumulative reward for selecting the action a₀ under the state s, and φ is a parameter of the Q-value function.

In some embodiments, the Q-value function includes:

$${E}_{( {s}_{i} , {a}_{i} , {s}_{i + 1} ) \sim D , {a}_{t + 1}^{0} \sim {π}_{θ} ,} [ {‖ ( r ( {s}_{i} , {a}_{i} ) + γ \times {min}_{j = 1 , 2} {Q}_{{φ}_{j}^{′}} ( {s}_{i + 1} , {a}_{i + 1}^{0} ) ) - {Q}_{φ j} ( {s}_{i} , {a}_{i} ) ‖}^{2} ] ,$$

where
(sᵢ, aᵢ, sᵢ₊₁)˜D represents sampling of a state-action pair from the empirical dataset D, and the state sᵢ₊₁ represents a next state after performing the selected action aᵢ under the state sᵢ,

$${a}_{i + 1}^{0} ∼ {π}_{θ} ,$$

represents that a new scheduling action

$${a}_{i + 1}^{0}$$

is generated from the scheduling strategy

$${π}_{{θ}^{′}} , {a}_{i + 1}^{0}$$

is generated by the scheduling strategy parameter θ′,
r (sᵢ, aᵢ) represents an immediate reward obtained by performing the action aᵢ under the state sᵢ, and
γ represents an influence level of a future reward on the currently determined scheduling strategy,

$$0 \leq γ \leq 1 .$$

Here, the min function can ensure that the reinforcement learning model selects relatively conservative actions to reduce risks.

r(sᵢ, aᵢ) can be used to measure the impact of actions in the scheduling strategy to be performed on various scheduling goals (e.g., delays, resource utilization, etc.). Multiple scheduling goals can be balanced by r(sᵢ, aᵢ). For example, the immediate reward for the action aᵢ that can achieve a desired goal under the state sᵢ may be set larger. In some embodiments, r(sᵢ, aᵢ) is configured to promote the minimization of delay time and the maximization of resource utilization. By configuring r(sᵢ, aᵢ) to promote the minimization of delay time and the maximization of resource utilization, the scheduling strategy generated by the neural network model may be caused to tend to minimize the delay time of the train and maximize the utilization of various resources, thereby improving the operating efficiency and resource utilization of the train. Of course, it can be understood that according to the actual scheduling needs of the train, r(sᵢ, aᵢ) may also be configured to balance other multiple scheduling goals (e.g., minimizing the number of stations for the train to stop, minimizing the operation time of a certain journey of the train, etc.) to generate different scheduling strategies.

Additionally, or alternatively, in some embodiments, train scheduling constraints, such as train interval time, station stop requirements, etc., may be imposed by r(sᵢ, aᵢ) to better meet the actual needs of train scheduling.

In addition, γ can be used to weigh long-term and short-term benefits. The larger the γ, the greater the degree of impact of the future reward on the currently determined scheduling strategy. Larger values of γ will make the model pay more attention to long-term returns, while smaller values of γ will emphasize immediate benefits.

At step S106, the train scheduling system is instructed to perform the generated scheduling strategy. For example, the train scheduling system may include one or more execution apparatus, each of which can perform a corresponding action in the scheduling strategy. As non-limiting examples, the execution apparatus may include one or more of: a power apparatus, a brake apparatus, a distributed-power traction apparatus, an automatic train protection (ATP) system, an automatic train control (ATC) system, an information service systems, etc.

Therefore, through the forward diffusion process in model training and the reverse diffusion process in model inference, the method for train re-scheduling according to various embodiments of the present disclosure can maintain stable scheduling performance under complex and dynamic conditions, and achieve excellent scheduling efficiency and robustness. The present disclosure further provides a method for training a neural network model for train re-scheduling. As described herein, the neural network model according to the present disclosure includes a diffusion model and a reinforcement learning model. FIG. 2 is referred to, which is a flowchart showing a method 200 of training a neural network model for train re-scheduling according to some embodiments of the present disclosure.

As shown in FIG. 2, the method 200 includes: at step S202, obtaining historical time series data indicating states, including a train operation state, a resource allocation state and an external environment state, at respective time points during a historical train operation process and a historical train scheduling strategy corresponding to the historical train operation process, the historical train scheduling strategy including an action that was performed by a train scheduling system; at step S204, adding noise to the historical time series data based on a forward diffusion process through a diffusion model to obtain noise-added historical time series data; and at step S206, training the reinforcement learning model by using the noise-added historical time series data as sample data and using the historical train scheduling strategy as label data.

For various embodiments of the method 200, the embodiments related to training the neural network model in the aforementioned method 100 may be similarly referred to, and will not be described repeatedly here.

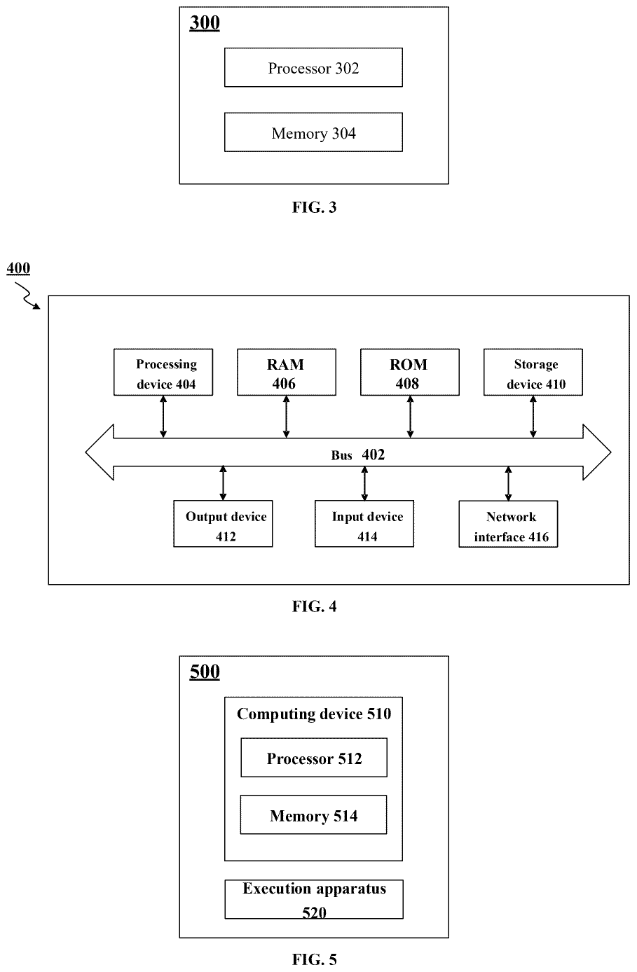

The present disclosure further provides a computing device. FIG. 3 is referred to, which is a schematic block diagram showing a computing device 300 according to some embodiments of the present disclosure. As shown in FIG. 3, the computing device 300 includes a processor 302 and a memory 304 storing computer executable instructions. The computer executable instructions, when executed by the processor 302, cause the processor 302 to execute the method for train re-scheduling or the method for training a neural network model for train re-scheduling according to any of the foregoing embodiments of the present disclosure. The processor 302 may be, for example, a central processing unit (CPU) of the computing device 300. The processor 302 may be any type of general-purpose processor, or may be a processor specifically designed for train re-scheduling or training a neural network model for train re-scheduling, such as an application-specific integrated circuit (“ASIC”). The memory 304 may be coupled to the processor 302 and may include various computer-readable media accessible by the processor 302. In various embodiments, the memory 304 described herein may include volatile and non-volatile media, removable and non-removable media. For example, the memory 304 may include any combination of random access memory (“RAM”), dynamic RAM (“DRAM”), static RAM (“SRAM”), read-only memory (“ROM”), flash memory, cache memory, and/or any other type of non-transitory computer-readable medium. The memory 304 may store instructions that, when executed by the processor 302, cause the processor 302 to perform the method for train re-scheduling or the method of training a neural network model for train re-scheduling according to any of the foregoing embodiments of the present disclosure.

The present disclosure further provides a non-transitory computer-readable storage medium having computer executable instructions stored thereon. The computer executable instructions, when executed by a processor, cause the processor to perform the method for train re-scheduling according to any of the foregoing embodiments of the present disclosure or the method for training a neural network model for train re-scheduling according to any of the foregoing embodiments.

The present disclosure further provides a computer program product, which may include instructions that can, when executed by a processor, implement the method for train re-scheduling according to any of the foregoing embodiments of the present disclosure or the method for training a neural network model for train re-scheduling according to any of the foregoing embodiments. The instructions may be any set of instructions to be executed directly by the processor, such as machine code, or any set of instructions to be executed indirectly, such as a script. The instructions may be stored in an object code format for direct processing by the processor, or in any other computer language, including a script or collection of independent source code modules that are interpreted on demand or compiled in advance.

FIG. 4 is a schematic block diagram showing a computer system 400 on which the embodiments of the present disclosure may be implemented. The computer system 400 includes a bus 402 or other communication mechanism for transmitting information, and a processing apparatus 404 coupled to the bus 402 for processing information. The computer system 400 further includes a memory 406 coupled to the bus 402 for storing instructions to be executed by the processing apparatus 404, which may be a random-access memory (RAM) or other dynamic storage device. The memory 406 may also be used to store temporary variables or other intermediate information during the execution of instructions to be executed by the processing apparatus 404. The computer system 400 further includes a read-only memory (ROM) 408 or other static storage device coupled to the bus 402 for storing static information and instructions for the processing apparatus 404. A storage apparatus 410 such as a magnetic disk or optical disk is provided and coupled to the bus 402 for storing information and instructions. The computer system 400 may be coupled via the bus 402 to an output device 412 for providing output to a user, such as, but not limited to, a display (such as a cathode ray tube (CRT) or a liquid crystal display (LCD)), a speaker, etc. An input device 414 such as a keyboard, a mouse, a microphone, etc. is coupled to the bus 402 for transmitting information and command selections to the processing apparatus 404. The computer system 400 can perform the embodiments of the present disclosure. Consistent with certain implementations of the present disclosure, the results are provided by the computer system 400 in response to the processing apparatus 404 executing one or more sequences of one or more instructions contained in the memory 406. Such instructions may be read into the memory 406 from another computer-readable medium such as the storage apparatus 410. The execution of the sequence of instructions contained in the memory 406 causes the processing apparatus 404 to perform the methods described herein. Alternatively, hard-wired circuitry may be used in place of or in combination with software instructions to implement the present teachings. Therefore, implementations of the present disclosure are not limited to any particular combination of hardware circuitry and software. In various embodiments, the computer system 400 may be connected to one or more other computer systems like the computer system 400 across a network via a network interface 416 to form a networked system. The network may include a private network or a public network such as the Internet. In the networked system, one or more computer systems can store data and serve data to other computer systems. The term “computer-readable medium” as used herein refers to any medium that participates in providing instructions to the processing apparatus 404 for execution. Such media may take many forms, including but not limited to non-volatile media, volatile media, and transmission media. Non-volatile media include, for example, optical disks or magnetic disks such as the storage apparatus 410. Volatile media include dynamic memories such as the memory 406. Transmission media include coaxial cables, copper wires, and optical fibers, including wiring that comprises the bus 402. Common forms of computer-readable media or computer program products include, for example, floppy disks, flexible disks, hard disks, magnetic tapes, or any other magnetic media, CD-ROMs, digital video disks (DVDs), Blu-ray disks, any other optical media, thumb drives, memory cards, RAMs, PROMs and EPROMS, flash EPROMs, any other memory chips or cartridges, or any other tangible media from which a computer can read. Various forms of computer-readable media may be involved in carrying one or more sequences of one or more instructions to the processing apparatus 404 for execution. For example, the instructions may initially be carried on a disk of a remote computer. The remote computer may load the instructions into its dynamic memory and send the instructions over a telephone line using a modem. A modem local to the computer system 400 may receive the data on the telephone line and convert the data into an infrared signal using an infrared transmitter. An infrared detector coupled to the bus 402 may receive the data carried in the infrared signal and place the data on the bus 402. The bus 402 carries the data to the memory 406, and the processing apparatus 404 retrieves the instructions from the memory 406 and executes the instructions. Optionally, the instructions received by the memory 406 may be stored on the storage apparatus 410 before or after execution by the processing apparatus 404.

According to various embodiments, computer-executable instructions for performing the described method may be stored on a computer-readable medium. The computer-readable medium may be any physical storage device capable of storing digital information. For example, the computer-readable medium may include a compact disc read-only memory (CD-ROM) for storing software. The computer-readable medium may be accessed by a processor configured to execute the stored instructions.

The present disclosure further provides a train scheduling system. FIG. 5 is a schematic block diagram showing a train scheduling system 500 according to some embodiments of the present disclosure. The train scheduling system 500 includes a computing device 510, which includes a processor 512 and a memory 514 that coupled to the processor 512 and stores instructions. For example, the computing device 510 may take the form of, but is not limited to, the aforementioned computing device 300 or computer system 400, etc. The memory 514 may store instructions that, when executed by the processor 512, cause the processor 512 to execute the method for train re-scheduling according to any of the aforementioned embodiments of the present disclosure. The train scheduling system 500 further includes an execution apparatus 520 that is communicably coupled to the computing device 510 and configured to perform a scheduling strategy in response to receiving the scheduling strategy from the computing device 510. As a non-limiting implementation, the execution apparatus 520 may include one or more of: a power apparatus, a brake apparatus, a distributed-power traction apparatus, an ATP system, an ATC system, an information service system, etc.

Specifically, in some embodiments, the instructions stored in the memory 514, when executed by the processor 512, can cause the processor 512 to: obtain time series data indicating states, including a train operation state, a resource allocation state and an external environment state, at respective time points during a train operation process; provide the obtained time series data to a trained neural network model to generate a scheduling strategy for train re-scheduling, the scheduling strategy including an action to be performed by a train scheduling system; and send the generated scheduling strategy to the execution apparatus communicatively coupled to the computing device, where the time series data has different noise in a case where an emergency occurs during the train operation process compared with a case where no emergency occurs during the train operation process, and where the neural network model includes a diffusion model and a reinforcement learning model, the diffusion model is configured to remove the noise in the time series data based on a reverse diffusion process to obtain denoised time series data, and the reinforcement learning model is configured to generate the scheduling strategy based on the denoised time series data.

For example, when an emergency of “heavy rainfall in a local area of Shanghai” occurs in the train operation process, the computing device 510 can generate a scheduling strategy including redetermined train departure time and arrival time according to the emergency and send the generated scheduling strategy to the execution apparatus 520, so that the power apparatus and the distributed-power traction apparatus, serving as the execution apparatus 520, can adjust, based on the scheduling strategy, the train running speed to adapt to the redetermined train departure time and arrival time, thereby avoiding safety hazards due to rainfall. In addition, the information service system serving as the execution apparatus 520 can update the train departure time and arrival time to notify passengers in time, thereby avoiding the passengers being unaware of changes in train scheduling strategies due to rainfall and unable to catch the train on time, which improves the passenger experience.

For various embodiments of train scheduling system 500, any embodiment of the aforementioned method of the present disclosure may be similarly referred to, and will not be described repeatedly here.

Therefore, the train scheduling system according to the present disclosure can quickly adjust the train scheduling strategy according to various emergencies that occur in the train operation process and perform the adjusted train dispatching strategy, so that the train can handle various emergencies, thereby ensuring the safety and reliability of the train operation.

One or more illustrative embodiments of the present disclosure are described above. Other embodiments are within the scope of the appended claims. In some cases, the actions or steps recited in the claims can be performed in an order different from that in the embodiments, while still achieving the intended results. In addition, the processes illustrated in the drawings do not necessarily require the specific order or continuous order shown to achieve the desired results. In some embodiments, multitasking and parallel processing are also possible or may be advantageous.

The systems, apparatuses, modules or units described in the above embodiments may be specifically implemented by computer chips or entities, or by products with certain functions. A typical implementation device is a server system. Of course, the present disclosure does not exclude that with the development of computer technology in the future, the computer that implements the functions of the above embodiments may be, for example, a personal computer, a laptop computer, a vehicle-mounted human-computer interaction device, a cellular phone, a camera phone, a smart phone, a personal digital assistant, a media player, a navigation device, an email device, a game console, a tablet computer, a wearable device, or a combination of any of these devices.

Although one or more embodiments of the present disclosure provide method operation steps as described in the embodiments or flowcharts, more or fewer operation steps may be included based on conventional or non-creative means. The order of steps listed in the embodiments is only one way of numerous performing orders of steps and does not represent the only performing order. When executed in an apparatus or terminal product in practice, the steps may be performed in sequence or in parallel according to the method order shown in the embodiments or the drawings (for example, in a parallel processor or multi-threaded processing environment, or even a distributed data processing environment).

The terms “comprise”, “include” or any other variations thereof are intended to cover non-exclusive inclusion, so that a process, method, product or device including a series of elements includes not only those elements, but also other elements not explicitly listed, or also includes elements inherent to such process, method, product or device. In the absence of further restrictions, it is not excluded that there are other identical or equivalent elements in the process, method, product or device including the described elements. For example, if the words “first”, “second” and the like are used to indicate names, they do not indicate any particular order.

For the convenience of description, the above apparatuses are described in various modules according to their functions. Of course, when implementing one or more embodiments of the present disclosure, the functions of the modules can be implemented in the same or multiple software and/or hardware, or the modules implementing the same function can be implemented by a combination of multiple sub-modules or sub-units, etc. The apparatus embodiments described above are only schematic. For example, the division of the units is only a logical function division. There may be other division methods in actual implementation. For example, multiple units or components may be combined or integrated into another system, or some features may be ignored or not executed. Another point is that the mutual coupling or direct coupling or communication connection shown or discussed may be indirect coupling or communication connection implemented through some interfaces, apparatuses or units, and may be in electrical, mechanical or other forms.

The present disclosure is described with reference to the flowchart and/or block diagram of the method, apparatus (system), and computer program product according to the embodiment of the present disclosure. It should be understood that each process and/or box in the flowchart and/or block diagram, as well as the combination of the processes and/or boxes in the flowchart and/or block diagram can be implemented by computer program instructions. These computer program instructions may be provided to a processor of a general-purpose computer, a special-purpose computer, an embedded processor or other programmable data processing device to produce a machine, so that the instructions executed by the processor of the computer or other programmable data processing device produce an apparatus for implementing the functions specified in one or more processes in the flowchart and/or one or more boxes in the block diagram.

These computer program instructions may also be stored in a computer-readable memory capable of directing the computer or other programmable data processing device to operate in a particular manner, so that the instructions stored in the computer-readable memory produce an article of manufacture including an instruction apparatus that implements the functions specified in one or more processes of a flowchart and/or one or more blocks of a block diagram. These computer program instructions may also be loaded onto the computer or other programmable data processing device, so that a series of operating steps are executed on the computer or other programmable device to produce a computer-implemented process, so that the instructions executed on the computer or other programmable device provide steps for implementing the functions specified in one or more processes of a flowchart and/or one or more blocks of a block diagram.

Those skilled in the art should understand that one or more embodiments of the present disclosure may be in the form of a complete hardware embodiment, a complete software embodiment, or an embodiment combining software and hardware. Moreover, one or more embodiments of the present disclosure may be in the form of a computer program product implemented on one or more computer-usable storage media (including but not limited to disk storage, CD-ROM, optical storage, etc.) containing computer-usable program codes therein.

One or more embodiments of the present disclosure may be described in the general context of computer-executable instructions executed by a computer, such as program modules. Generally, the program modules include routines, programs, objects, components, data structures, etc. that perform specific tasks or implement specific abstract data types. One or more embodiments of the present disclosure may also be practiced in distributed computing environments where tasks are performed by remote processing devices connected through a communications network. In a distributed computing environment, the program modules may be located in local and remote computer storage media, including storage devices.

The same or similar parts between the various embodiments of the present disclosure may be referred to one another, and each embodiment focuses on the differences from other embodiments. In particular, for the device embodiment, since it is basically similar to the method embodiment, the description thereof is relatively simple, and the description of the method embodiment may be referred to for the relevant parts of the device embodiment. In the description of the present disclosure, the description of the reference terms “one embodiment”, “some embodiments”, “example”, “specific example”, or “some examples”, etc. means that the specific features, structures, materials or characteristics described in conjunction with the embodiment or example are included in at least one embodiment or example of the present disclosure. In the present disclosure, the schematic representation of the above terms is not necessarily directed to the same embodiment or example. Moreover, the specific features, structures, materials or characteristics described may be combined in any one or more embodiments or examples in a suitable manner. In addition, those skilled in the art can combine and merge the different embodiments or examples described in the present disclosure and the features of the different embodiments or examples without contradiction.

In addition, when used in the present disclosure, the words “herein”, “above”, “below”, “hereafter”, “foregoing” and words of similar meaning shall refer to the present disclosure as a whole rather than to any particular portion of the present disclosure. Furthermore, unless expressly stated otherwise or understood otherwise in the context of use, conditional language used herein, such as “may,” “might,” “for example,” “such as,” and the like, is generally intended to express that some embodiments include, while other embodiments do not include, some features, elements, and/or states. Thus, such conditional language is generally not intended to imply that one or more embodiments require features, elements, and/or states in any way, or whether these features, elements, and/or states are included, or whether these features, elements, and/or states are performed in any particular embodiment.

The above description is only examples of one or more embodiments of the present disclosure, and is not intended to limit one or more embodiments of the present disclosure. For those skilled in the art, one or more embodiments of the present disclosure may have various changes and variations. Any modification, equivalent substitution, improvement, etc. made within the spirit and principle of the present disclosure shall be included in the scope of the claims.

What is claimed is:

1. A method for train re-scheduling, comprising:
obtaining time series data indicating states at respective time points during a train operation process, the states comprising a train operation state, a resource allocation state and an external environment state;
providing the obtained time series data to a trained neural network model to generate a scheduling strategy for train re-scheduling, the scheduling strategy comprising an action to be performed by a train scheduling system; and
instructing the train scheduling system to perform the generated scheduling strategy,
wherein the time series data has different noise in a case where an emergency occurs during the train operation process compared with a case where no emergency occurs during the train operation process, and
wherein the neural network model comprises a diffusion model and a reinforcement learning model, the diffusion model is configured to remove the noise in the time series data based on a reverse diffusion process to obtain denoised time series data, and the reinforcement learning model is configured to generate the scheduling strategy based on the denoised time series data.

2. The method according to claim 1, wherein
the time series data has different noise in a case where a first emergency occurs during the train operation process compared with a case where a second emergency occurs during the train operation process, and
the first emergency has a different type from that of the second emergency, or the first emergency has a different priority from that of the second emergency.

3. The method according to claim 1, wherein removing the noise in the time series data based on the reverse diffusion process comprises:
$${x}_{t - 1} = \frac{1}{\sqrt{{α}_{t}}} [ {x}_{t} - \frac{1 - {α}_{t}}{\sqrt{1 - {β}_{t}}} {ε}_{θ} ( {x}_{t} , t ) ] + {σ}_{t} z ,$$
where
the time series data comprises (T+1) time points, the time series data indicates a state x₀ at time point 0 and indicates a state x_{T} at time point T,
the reverse diffusion process is defined as a diffusion process from the state x_{T} to the state x₀ along a Markov chain consisting of T time steps, t is a time step in the Markov chain, where t ∈[1, T],
the state xₜ₋₁ represents a state obtained from the state xₜ after one step of denoising,
ε_{θ}(x, t) represents noise predicted for the state xₜ and the time step t, θ represents a scheduling strategy parameter,
$${α}_{t} = 1 - {β}_{t} , {β}_{t} = {σ}_{t}^{2} ,$$
σₜ represents a noise coefficient at the time step t, and
z represents Gaussian noise.

4. The method according to claim 3, wherein σₜ is determined based on an emergency occurring at the time step t.

5. The method according to claim 4, wherein σₜ is determined based on one of following noise strategies:
σₜ is determined as
$${σ}_{min} + \frac{t}{T} ( {σ}_{max} - {σ}_{min} )$$
based on a linear noise strategy; or
σₜ is determined as
$${σ}_{t} = {σ}_{max} \cdot cos ( \frac{π t}{2 T} )$$
based on an cosine noise strategy, or
σₜ is determined as
$${σ}_{min} \cdot {( \frac{{σ}_{max}}{{σ}_{min}} )}^{\frac{t}{T}}$$
based on an exponential noise strategy,
where
σₘᵢₙ represents a minimum noise coefficient for the T time steps, and
σₘₐₓ represents a maximum noise coefficient for the T time steps.

6. The method according to claim 5, further comprising:
selecting the linear noise strategy in response to no emergency occurring at the time step t; or
selecting the cosine noise strategy in response to an emergency with a first priority occurring at the time step t; or
selecting the exponential noise strategy in response to an emergency with a second priority, higher than the first priority, occurring at the time step t.

7. The method according to claim 1, wherein the neural network model is trained by following steps:
obtaining historical time series data indicating states at respective time points during a historical train operation process and a historical train scheduling strategy corresponding to the historical train operation process, the states comprising a train operation state, a resource allocation state and an external environment state, the historical train scheduling strategy comprising an action that was performed by a train scheduling system;
adding noise to the historical time series data based on a forward diffusion process through the diffusion model to obtain noise-added historical time series data; and
training the reinforcement learning model by using the noise-added historical time series data as sample data and using the historical train scheduling strategy as label data.

8. The method according to claim 7, wherein adding the noise to the historical time series data based on the forward diffusion process comprises:
$${x}_{t} = \sqrt{{α}_{t}} {x}_{0} + \sqrt{1 - {α}_{t}} ε ,$$
where
the historical time series data comprises (T+1) time points, the historical time series data indicates a state x₀ at time point 0 and indicates a state x_{T} at time point T,
the forward diffusion process is defined as a diffusion process from the state x₀ to the state x_{T} along a Markov chain consisting of T time steps, t is a time step t in the Markov chain, where t∈[1, T],
the state xₜ represents a state obtained from the state x₀ after t steps of noise-adding,
αₜ represents a weight coefficient used to control noise-adding at the time step t, and
ε represents Gaussian noise.

9. The method according to claim 8, wherein αₜ decreases with increase of t.

10. The method according to claim 8, wherein
$${α}_{t} = 1 - {σ}_{t}^{2} ,$$
where σₜ represents a noise coefficient at the time step t, and σₜ is determined based on an emergency that is simulated to occur at the time step t,
wherein σₜ is determined based on one of following noise strategies:
σₜ is determined as
$${σ}_{min} + \frac{t}{T} ( {σ}_{max} - {σ}_{min} )$$
based on a linear noise strategy; or
σₜ is determined as
$${σ}_{t} = {σ}_{max} \cdot cos ( \frac{π t}{2 T} )$$
based on a cosine noise strategy; or
σₜ is determined as
$${σ}_{min} \cdot {( \frac{{σ}_{max}}{{σ}_{min}} )}^{\frac{t}{T}}$$
based on an exponential noise strategy,
where
σₘᵢₙ represents a minimum noise coefficient for the T time steps, and
σₘₐₓ represents a maximum noise coefficient for the T time steps.

11. The method according to claim 10, further comprising:
selecting the linear noise strategy in response to simulating that no emergency occurs at the time step t; or
selecting the cosine noise strategy in response to simulating that an emergency with a first priority occurs at the time step t; or
selecting the exponential noise strategy in response to simulating that an emergency with a second priority, higher than the first priority, occurs at the time step t.

12. The method according to claim 1, wherein
the emergencies comprise device failure, bad weather, passenger emergency;
the train operation state comprises a current position, a speed, and planned arrival time of the train; the resource allocation state comprises a station condition and track availability; the external environment state comprises a weather condition, a device condition, a passenger condition; and actions that can be performed by the train scheduling system comprise determining train departure time and arrival time, determining train operation priority, selecting a track, and selecting a station.

13. A method for training a neural network model for train re-scheduling, the neural network model comprising a diffusion model and a reinforcement learning model, and the method comprising:
obtaining historical time series data indicating states at respective time points during a historical train operation process and a historical train scheduling strategy corresponding to the historical train operation process, the states comprising a train operation state, a resource allocation state and an external environment state, the historical train scheduling strategy comprising an action that was performed by a train scheduling system;
adding noise to the historical time series data based on a forward diffusion process through the diffusion model to obtain noise-added historical time series data; and
training the reinforcement learning model by using the noise-added historical time series data as sample data and using the historical train scheduling strategy as label data.

14. The method according to claim 13, wherein adding the noise to the historical time series data based on the forward diffusion process comprises:
$${x}_{t} = \sqrt{{α}_{t}} {x}_{0} + \sqrt{1 - {α}_{t}} ε ,$$
where
the historical time series data comprises (T+1) time points, the historical time series data indicates a state x₀ at time point 0 and indicates a state x_{T} at time point T,
the forward diffusion process is defined as a diffusion process from the state x₀ to the state x_{T} along a Markov chain consisting of T time steps, t is a time step t in the Markov chain, where t∈[1, T],
the state xₜ represents a state obtained from the state x₀ after t steps of noise-adding,
αₜ represents a weight coefficient used to control noise-adding at the time step t, and
ε represents Gaussian noise.

15. The method according to claim 14, wherein
$${α}_{t} = 1 - {σ}_{t}^{2} ,$$
where σₜ represents a noise coefficient at the time step t, and σₜ is determined based on an emergency that is simulated to occur at the time step t,
wherein σₜ is determined based on one of following noise strategies:
σₜ is determined as
$${σ}_{min} + \frac{t}{T} ( {σ}_{max} - {σ}_{min} )$$
based on a linear noise strategy; or
σₜ is determined as
$${σ}_{t} = {σ}_{max} \cdot cos ( \frac{π t}{2 T} )$$
based on a cosine noise strategy; or
σₜ is determined as
$${σ}_{min} \cdot {( \frac{{σ}_{max}}{{σ}_{min}} )}^{\frac{t}{T}}$$
based on an exponential noise strategy,
where
σₘᵢₙ represents a minimum noise coefficient for the T time steps, and
σₘₐₓ represents a maximum noise coefficient for the T time steps,
wherein the method comprises:
selecting the linear noise strategy in response to simulating that no emergency occurs at the time step t; or
selecting the cosine noise strategy in response to simulating that an emergency with a first priority occurs at the time step t; or
selecting the exponential noise strategy in response to simulating an emergency with a second priority, higher than the first priority, occurs at the time step t.

16. A computing device, comprising:
a processor; and
a memory storing computer executable instructions that, when executed by the processor, cause the processor to perform the method according to claim 1.

17. A non-transitory computer-readable storage medium having computer executable instructions stored thereon that, when executed by a processor, cause the processor to perform the method according to claim 1.

18. A computing device, comprising:
a processor; and
a memory storing computer executable instructions that, when executed by the processor, cause the processor to perform the method according to claim 13.

19. A non-transitory computer-readable storage medium having computer executable instructions stored thereon that, when executed by a processor, cause the processor to perform the method according to claim 13.

20. A train scheduling system, comprising:
a computing device comprising a processor and a memory coupled to the processor and storing instructions that, when executed by the processor, cause the processor to:
obtain time series data indicating states at respective time points during a train operation process, the states comprising a train operation state, a resource allocation state and an external environment state;
providing the obtained time series data to a trained neural network model to generate a scheduling strategy for train re-scheduling, the scheduling strategy comprising an action to be performed by a train scheduling system,
wherein the time series data has different noise in a case where an emergency occurs during the train operation process compared with a case where no emergency occurs during the train operation process, and
wherein the neural network model comprises a diffusion model and a reinforcement learning model, the diffusion model is configured to remove the noise in the time series data based on a reverse diffusion process to obtain denoised time series data, and the reinforcement learning model is configured to generate the scheduling strategy based on the denoised time series data; and
send the generated scheduling strategy to an execution apparatus communicatively coupled to the computing device; and
the execution apparatus configured to perform the scheduling strategy in response to receiving the scheduling strategy from the computing device.
